(19) United States
(12) Patent Application Publication
(10) Pub. No.: US 2008/0101850 A1
(43) Pub. Date: May 1, 2008

(54) Applicator

(76) Inventors: Michael Wojcik, Plainfield, IL (US); Kelly Sanborn, Naperville, IL (US); Susan Kenn, Chicago, IL (US)

Correspondence Address: LADAS & PARRY LLP, 224 SOUTH MICHIGAN AVENUE, SUITE 1600, CHICAGO, IL, 60604, US

(21) Appl. No.: 11/492,651

(22) Filed: Jul. 25, 2006

(51) Int. Cl. B43K 1/06; B43K 5/06

(52) U.S. Cl. 401/265; 401/263; 401/262; 401/175; 401/172

(57) ABSTRACT

An emollient applicator particularly suited for use with liquid, semi-solid ointment or gel lip care products. The applicator tip has protrusions that may be hard or soft and resilient for exfoliating and massaging a user's lips. The dispensing tube is preferably a solid tube. The driving mechanism and applicator tip are sealed with the dispensing tube to allow for use of a liquid, semi-solid ointment or gel within the applicator.

The invention pertains to an applicator for dispensing a liquid, semi-solid ointment or a gel. More particularly, the invention pertains to an applicator for dispensing lip care products or other cosmetics.

### FIELD OF THE INVENTION

Lip care products are generally made in either a liquid/gel form or a solid/balm form. The liquid or gel lip care products are preferred by some users because the liquid or gel is easier to apply to the entire surface of the lips, penetrates better into cracks in the lips, and is more easily absorbed into the lips. Solid lip care products, or balms, are generally made of a solid, waxy, composition. The solid lip care products are preferred by some users because it is not as likely to create a mess.

Lip care products are generally packaged for consumer use in the three ways: in a jar or tin, in a collapsible tube, or in a solid tube, such as a propel/repel stick.

Lip care products packaged in a jar or tin usually come in a gel or solid form. A consumer opens the jar or tin and uses their fingers to apply the lip care product to the lips. This is not a convenient package for the consumer since it leaves excess product on the consumer's fingers after use. Although, some consumers prefer this since they may use their fingers to rub and massage the product into the lips.

Lip care products packaged in a collapsible tube are usually in a liquid or gel form. A consumer squeezes the tube to dispense an amount of liquid or gel product from a nozzle. The product may then be applied directly to the lips. However, consumers sometimes also use their fingers to rub and massage the product into the lips. The collapsible tube package is avoided by some consumers because it does not fit as well into a pocket or purse, and/or there is a fear that the collapsible tube may be inadvertently squeezed when not in use and create a mess on the consumer, their clothes, or in their purse or elsewhere.

Lip care products packaged in a solid tube are usually in a solid, lipstick form—balm form. Some solid tube type applicators are also know as propel/repel sticks because the applicator is configured to both propel and repel the solid balm from the tube (stick) container. While this form does not penetrate and absorb into the lips as well as a liquid or gel, some consumers prefer the solid tube package since in fits well into a pocket or purse, and there is less likelihood of the product creating a mess.

The need exists for a lip care product that has the advantages of all forms and packages for the product, thus appealing to all consumers.

### SUMMARY OF THE INVENTION

A preferred embodiment of the present invention includes a solid tube type lip care product dispenser. The dispenser includes various seals to allow a liquid, semi-solid ointment or gel lip care product to be retained within the dispenser without leaking out or evaporating. An applicator tip is also provided through which the lip care product, also known as an emollient, is dispensed through a discharge opening. A cap with a pin is provided to prevent leakage and evaporation of the emollient through the discharge opening in the applicator tip. The face of the applicator tip is provided with a series of protrusions that may be used to exfoliate and massage the lips, providing better penetration and absorption of the emollient. The protrusions and the applicator tip may be hard, or made of a soft and resilient material to better enhance the exfoliating and massaging function of the applicator tip.

### BRIEF DESCRIPTION OF THE DRWING FIGURES

FIG. 1 is a top perspective view of a preferred embodiment of the applicator;

FIG. 2 is a side view thereof;

FIG. 3 is an enlarged cross-sectional view through line 3-3;

FIG. 4 is an enlarged partial sectional view of the dispensing tube and applicator inner seal, as shown in FIG. 3;

FIG. 5 is a top perspective view of a preferred embodiment of the applicator tip in which the series of protrusions is a soft and rigid material;

FIG. 6 is a top perspective view of a preferred embodiment of the applicator tip in which the face and protrusions are a soft and rigid material;

FIG. 7 is a top perspective view of a preferred embodiment of the applicator tip in which the face, protrusions, and side wall are a soft and rigid material;

FIGS. 8 and 9 are top perspective views of alternative preferred embodiments of the applicator tip.

### DETAILED DESCRIPTION OF THE PREFERRED EMBODIMENTS

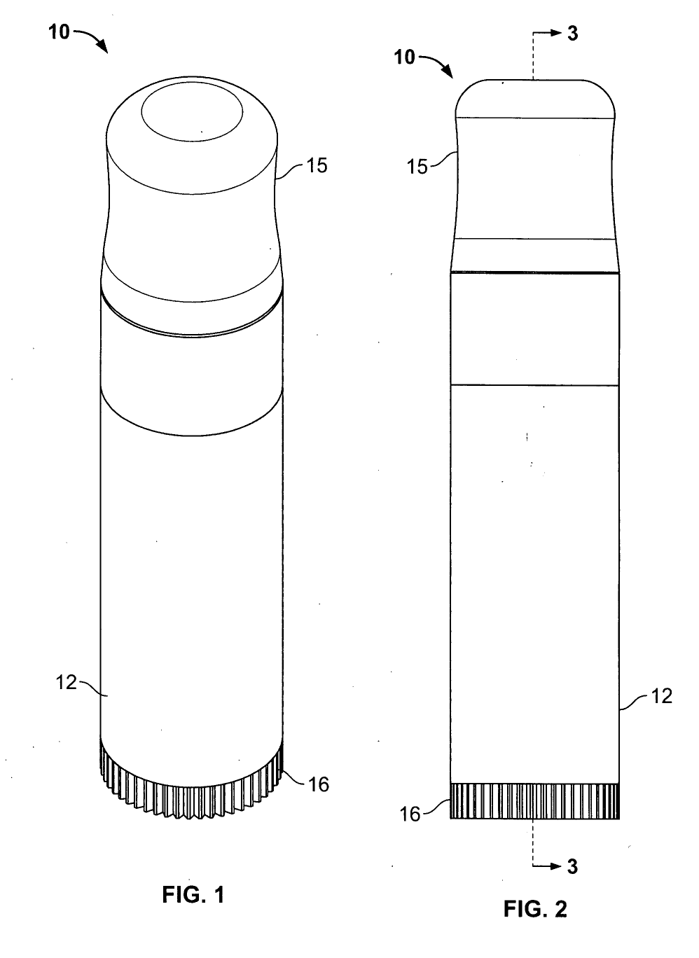

Referring to the drawing Figures, FIGS. 1 and 2 show a solid tube type applicator 10 having a dispensing tube 12, a drive mechanism 14 and a cap 16.

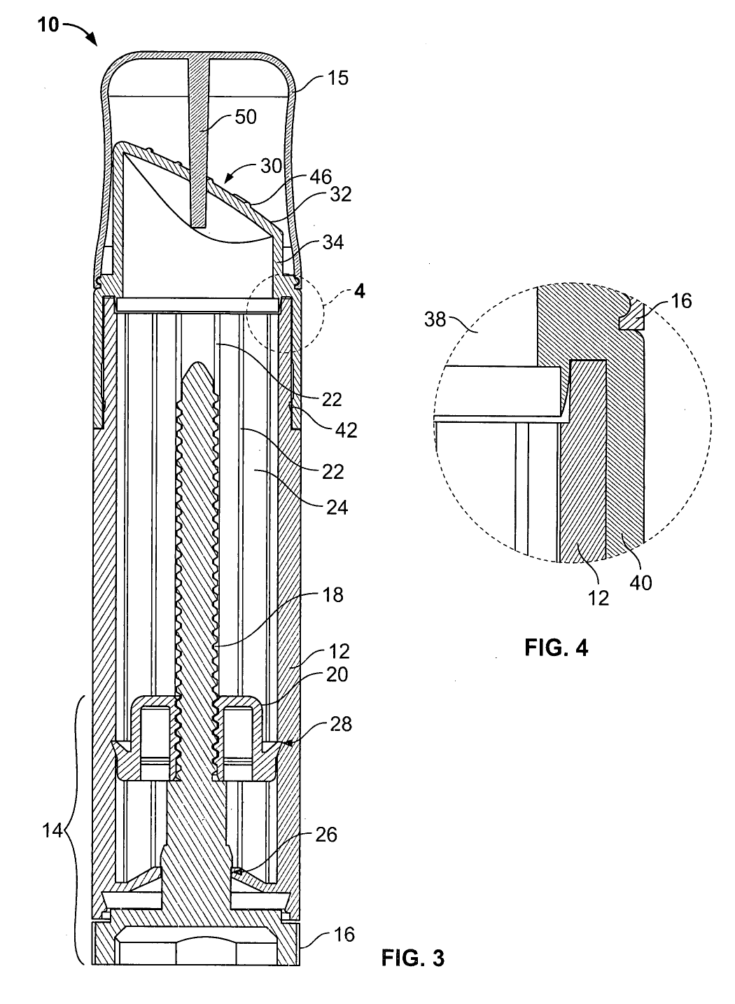

FIG. 3 is a cross-sectional view of the applicator 10 through line 3-3, and further depicts the inner components of the applicator 10. The drive mechanism 14 has three components: an actuating portion 16; a screw 18; and a piston 20. There are various configurations that such a screw mechanism 14 may take. However, the configuration which is shown, with the screw 18 passing through the piston 20, is preferred since it maintains the screw mechanism 14 compactly within the dispensing tube 12.

The piston 20 is transversely driven within the dispensing tube 12 along the screw 18 by turning the actuating portion 16. Grooves 22 are disposed in the inner wall 24 of the dispensing tube 12. The grooves 22 engage the piston 20, preventing axial rotation of the piston 20 within the dispensing tube 12.

A base seal 26 is provided between the actuating portion 16 and the dispensing tube 12. The base seal 26 provides an extra seal in the event that the piston seal 28 is breached. The piston seal 28 provides a tight fit between the piston 20 and the inner wall 24 of the dispensing tube 12. In this embodiment the piston seal 28 is made of rubber or some other soft and resilient material, and is angled transversely away from the actuator portion, and outward, to contact the inner wall 24. This configuration for the piston seal 28 acts as a “wiper” against the inner wall 24.

Tight machining tolerances between the screw 18 and the piston 20 provide the seal therebetween. The screw 18 and the piston 20 are usually manufactured from a plastic material which allows these two components to be sized and configured to press-fit against each other as the piston 20 traverses the length of the screw 18. The applicator tip 30 is fit on the end of the dispensing tube that is opposite from the actuating portion 16. The seals within the applicator allow it to function as a propel/repel type stick applicator.

It is noted that although the preferred use of the applicator tip is with a solid dispensing tube product, a collapsible dispensing tube may also be used in conjunction with the applicator tip 30.

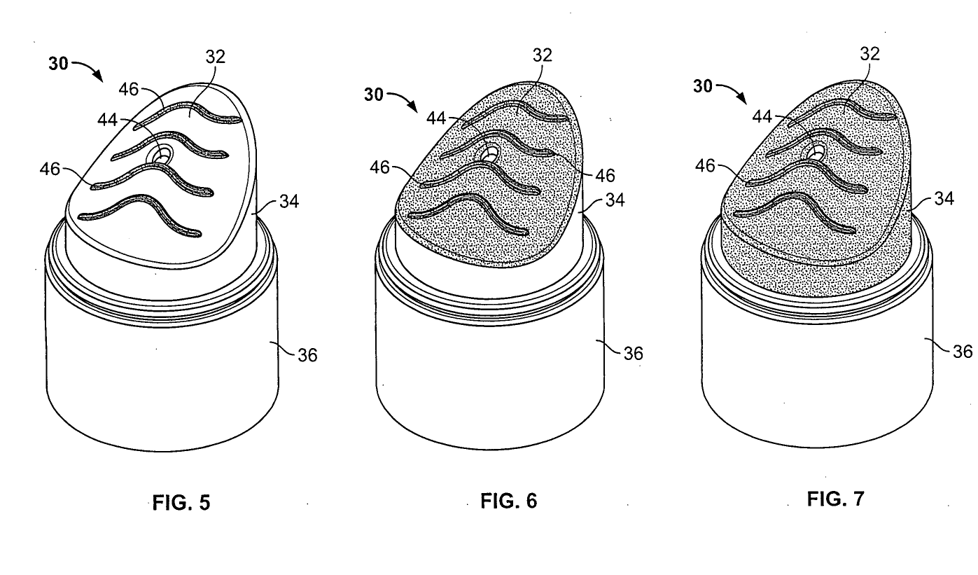

As is further depicted in FIGS. 5-9, the applicator tip 30 has a face portion 32 defined by a side wall 34 that extends to a base portion 36.

The base portion 36 preferably has a double seal as shown in FIGS. 3 and 4. The inner seal 38 is a plug-type of seal which is press-fit into the dispensing tube 12. The inner seal 38 seals against the inner wall 24. The outer seal 40 is an outer flap that surrounds and overlies the outer side of the dispensing tube 12. A snap-fit connection 42 may also be provided between the outer seal 40 and the outer side of the dispensing tube 12 to better retain and seal the applicator tip 30 onto an end of the dispensing tube 12.

The outer perimeter of the face portion 32 is defined by the sidewall 34. The face portion 32 may be angled and curved as is shown in the drawing figures. A discharge opening 44 is provided through the face portion 32.

On the face portion 32, a series of protrusions 46 are provided which may be rubbed against a user's lips to exfoliate and massage the lips. This is particularly useful to provide better penetration and absorption of an emollient into the lips. The protrusions 46 may be made in various sizes and shapes, and are not limited by what is shown on the drawings. Furthermore, the protrusions 46, the face portion 32 and the sidewalls may be made of a soft and resilient material. The soft and resilient material enhances the exfoliating and massaging function of the applicator tip. Preferably, a thermoplastic elastomer (TPE) is used as the soft and resilient material.

FIG. 5 shows an embodiment in which only the protrusions 46 are made of the soft and resilient material. FIG. 6 shows an embodiment in which the protrusions 46 and the face portion 32 are made of the soft and resilient material. FIG. 7 shows an embodiment in which the protrusions 46, face portion 32 and sidewalls 34 are made of the soft and resilient material.

A cap 16 is provided to cover the applicator tip 30. A pin 50 extends from inside the cap 16 to sealingly fit within the discharge opening 44 when the cap 16 is fit over the applicator tip 30. A snap-fit connection may be provided between the cap 16 and the base portion 36 of the applicator tip 30 to retain the cap 16 thereon.

Emollient (not shown) is provided in the space bounded by the piston 20, dispensing tube 12, and the applicator tip 30. By turning the actuator portion 16 of the screw mechanism 14 (drive mechanism), the piston 20 is moved transversely to either expel emollient through the discharge opening 44, or retract the emollient within the dispensing tube 12, depending on the direction the actuating portion 16 is turned.

The applicator thus described provides for use of a liquid, semi-solid ointment or gel lip care product with a solid tube package, and provides an exfoliating and massaging applicator tip for application of the lip care product on a user's lips.

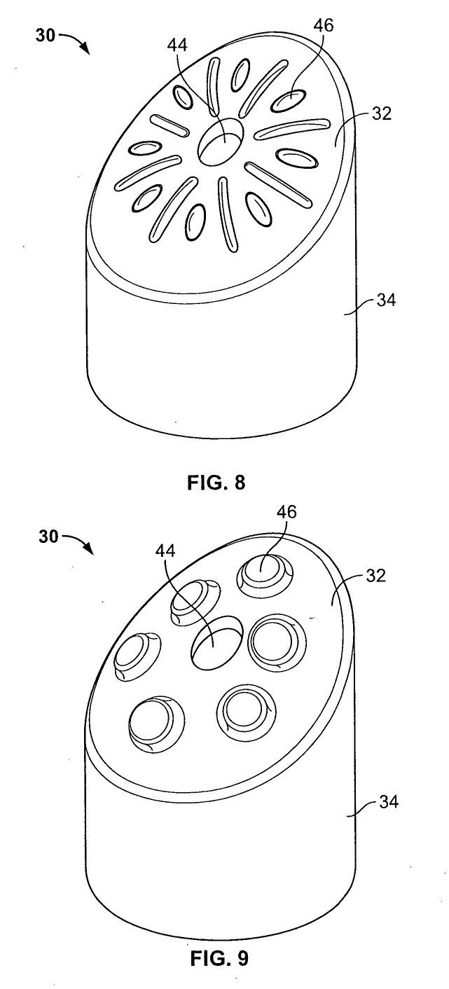

FIGS. 8 and 9 depict alternative preferred embodiments of the applicator tip, and share like reference numerals as depicted and described with reference to FIGS. 5-7.

While preferred embodiments of the invention have been depicted and described herein, various changes and modifications may be made to the invention without departing from the spirit and scope of the invention which is defined by the claims appended hereto.

1. An emollient applicator comprising:
a dispensing tube having an inner wall with grooves formed therein:
a piston inside the dispensing tube and engaging the grooves; and
an applicator face portion;
a side wall extending from the face portion;
a base portion;
a discharge opening located in the face portion, through which emollient passes in response to movement of the piston toward the applicator face portion; and
a series of protrusions disposed on the face portion.

2. The applicator tip of claim 1, wherein the protrusions are made of a hard material.

3. The applicator tip of claim 1, wherein at least the protrusions are made of a soft and resilient material.

4. The applicator tip of claim 3, wherein the face portion is made of a soft and resilient material.

5. The applicator tip of claim 4, wherein the side wall is made of a soft and resilient material.

6. The applicator tip of claim 3, wherein the soft and resilient material is a thermoplastic elastomer.

7. The applicator tip of claim 1, wherein the base portion includes an inner seal and an outer seal to seal the applicator tip at an end of a dispensing tube.

8. The a-applicator tip of claim 7, wherein the inner seal is a tapered plug-type seal which is press-fit within the end of the dispensing tube.

9. The applicator tip of claim 7, wherein the outer seal overlaps an outer side of the end of the dispensing tube.

10. The applicator tip of claim 9, wherein the outer seal is connected to the outer side of the end of the dispensing tube with a snap-fit connection.

11. An emollient applicator comprising:
a dispensing tube having an inner wall with grooves formed therein:
a piston inside the dispensing tube and engaging the grooves: and an applicator tip; and
a dispensing tube;
wherein said applicator tip comprises:
an applicator face portion;
a side wall extending from the face portion;
a base portion sealed to a first end of the dispensing tube;
a discharge opening located in the face portion, through which emollient passes in response to movement of the piston toward the applicator face portion; and
a series of protrusions disposed on the face portion.

12. (canceled)

13. The applicator of claim 11, wherein the piston has a piston seal disposed against an inner wall of the dispensing tube.

14. The applicator of claim 10, wherein the piston is driven by a screw mechanism.

15. The applicator of claim 14, wherein a screw of the screw mechanism passes through the piston.

16. (canceled)

17. The applicator of claim 14, wherein the screw mechanism is sealed against the dispensing tube near a second end of the dispensing tube, and an actuating portion of the screw mechanism is located adjacent to the second end.

18. The applicator of claim 11, wherein the base portion of the applicator tip includes an inner seal and an outer seal to seal the applicator tip at the first end of the dispensing tube.

19. The applicator of claim 19, wherein the inner seal is a tapered plug-type seal which is press-fit within the first end of the dispensing tube.

20. The applicator of claim 18, wherein the outer seal overlaps an outer side of the first end of the dispensing tube.

21. The applicator of claim 20, wherein the outer seal is connected to the outer side of the first end of the dispensing tube with a snap-fit connection.

22. The applicator of claim 11, further comprising a cap that fits over and is removably retained upon the applicator tip, the cap including a pin that is inserted within and seals against the discharge opening when the cap is retained over the applicator tip.
